(19) United States
(12) Patent Application Publication
(10) Pub. No.: US 2009/0311964 A1
(43) Pub. Date: Dec. 17, 2009

(54) COMMUNICATION APPARATUS AND CONTROL METHOD

(75) Inventor: Tetsuya Yamamoto, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/483,105

(22) Filed: Jun. 11, 2009

(30) Foreign Application Priority Data
Jun. 16, 2008 (JP) 2008-156898

(51) Int. Cl. H04B 15/00

(52) U.S. Cl. 455/63.3

(57) ABSTRACT

A communication apparatus which performs communication under control of a base station includes a detection unit to detect a signal sent from another wireless system interfering with a first frequency channel, a disconnection unit to disconnect communication performed in the first frequency channel when the signal interfering with the first frequency channel is detected, a determination unit to determine whether the base station is communicating using the first frequency channel when the communication has been disconnected, and a control unit, when it is determined that the base station is not communicating using the first frequency channel, to search for a second frequency channel used by the base station and communicate with the base station by using the second frequency channel and/or when the it is determined that the base station is communicating using the first frequency channel, to notify a user that communication has been disconnected.

### BACKGROUND OF THE INVENTION

1. Field of the Invention

The present invention relates to a communication apparatus and a control method for the same communication apparatus.

2. Description of the Related Art

There are radio frequency regulations that state that in a wireless Local Area Network (LAN) using 5 GHz frequency bands, when a radar signal is detected in a particular frequency channel, communication must not be carried out using this channel for a fixed period of time (30 minutes). This provision is intended to avoid interference between the wireless LAN and the radar.

The radio frequency regulations were issued in Japan by the Ministry of Internal Affairs and Communications, in Europe by the European Telecommunications Standards Institute (ETSI), or in the U.S. by the Federal Communications Commission (FCC).

The radio frequency regulations can be complied with by installing a dynamic frequency selection (DFS) function. The DFS function changes frequency channels to be used for communication to avoid interference from the radar or the like.

Depending on an installation site of a wireless LAN access point or detection timing of a radar signal, for example, a wireless LAN station connected to the access point may sometimes detect a radar signal before the radar signal is detected by the access point. However, such a case has not so far been earnestly considered. Further, an access point connected to a station is not necessarily provided with the DFS function, which has not so far been considered, either.

The interference of radio waves is not always caused by a radar signal and it can occur between wireless systems that use the same frequency band, and there is a system which, when it detects a signal from some other system, stops communication on the channel to prevent interference. Even in such a system, the station may detect a signal from other system before the access point detects the signal from the same other system and the access point may not have the DFS function, which have not been contemplated, either.

### SUMMARY OF THE INVENTION

The present invention is directed to a communication apparatus that performs communication under control of a base station. More specifically, the communication apparatus performs a process according to a state or a function of the base station when the communication apparatus detects a signal from another wireless system, such as a radar signal. Thus, the communication apparatus can improve convenience of users while abiding by the radio frequency regulations.

According to an aspect of the present invention, a communication apparatus which performs communication under control of a base station includes a detection unit configured to detect a signal sent from another wireless system interfering with a first frequency channel, a disconnection unit configured to disconnect communication using the first frequency channel when the detection unit detects the signal interfering with the first frequency channel, a determination unit configured to determine whether the base station is communicating using the first frequency channel when the disconnection unit has disconnected communication, and a control unit configured, when the determination unit determines that the base station is not communicating using the first frequency channel, to search for a second frequency channel which is used by the base station and communicate with the base station by using the searched second frequency channel and/or when the determination unit determines that the base station is communicating using the first frequency channel, to notify a user that communication has been disconnected.

Further features of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram of a wireless communication system including a wireless communication apparatus according to an exemplary embodiment of the present invention.

FIG. 2 is a table indicating frequency bands used in the wireless communication system according to the exemplary embodiment of the present invention.

FIG. 3 is a function block diagram illustrating a function configuration related to wireless communication according to the exemplary embodiment of the present invention.

FIG. 4 is a flowchart illustrating an operation of the wireless communication apparatus according to the exemplary embodiment of the present invention.

FIG. 5 is a flowchart illustrating an operation of the wireless communication apparatus according to the exemplary embodiment of the present invention.

### DETAILED DESCRIPTION OF THE EMBODIMENTS

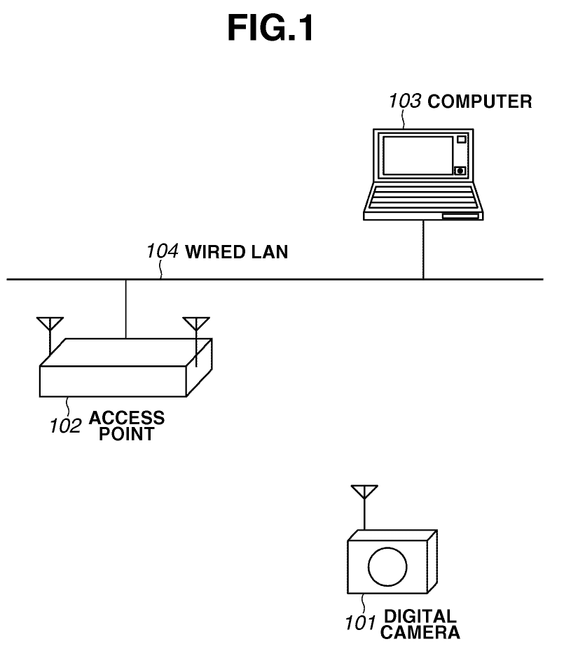

A configuration of a wireless communication system including a wireless communication apparatus according to a first exemplary embodiments of the present invention will be described below with reference to FIG. 1.

A wireless LAN used in the wireless communication system according to the first embodiment performs communication based on the Institute of Electrical and Electronic Engineers, Inc. (IEEE) 802.11 series of standards.

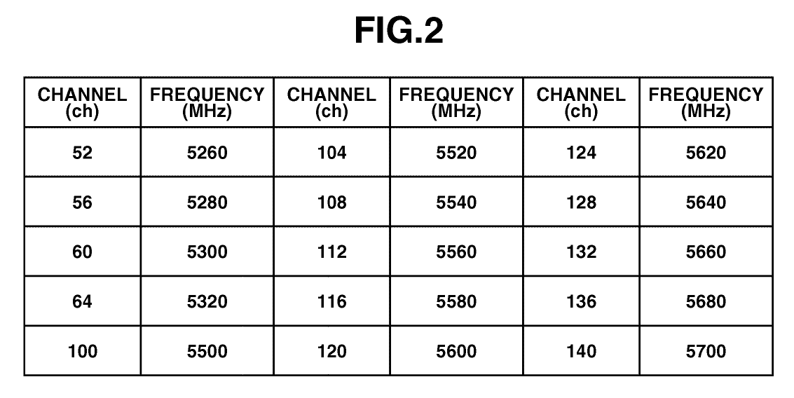

FIG. 2 indicates carrier frequencies and channels of 5.3 GHz band and 5.6 GHz band used in the wireless LAN of the present exemplary embodiment.

As examples of other wireless systems using those frequencies, there are radar systems, namely, a meteorological radar, a marine radar, and a military radar. The meteorological radar transmits radio waves into the air from an antenna installed in a meteorological observatory, and receives reflected waves from raindrops or snow in the air to measure locations and densities of rain or snow. The marine radar transmits radio waves from a ship and observes shore or another ship based on reflected waves therefrom. The military radar transmits radio waves from a military base or an airplane and receives reflected waves from a target object such as an airplane to observe a location of the target object and a changing distance from the target object.

When interference occurs between the radar and the wireless LAN, an accurate observation cannot be performed. When a radio wave from a radar system is detected, a wireless communication system which uses frequencies in FIG. 2 changes its channel to another channel by using the dynamic frequency selection (DFS) function to avoid interferences.

The wireless communication apparatus operates in an infrastructure mode. The infrastructure mode is a mode in which communication is performed via a base station (hereafter referred to as an access point) that controls other communication apparatuses.

A digital camera 101 includes a function of a communication apparatus (hereafter referred to as a station) that performs communication under control of an access point. The function of the station may be incorporated in the digital camera 101, or may be detachably mounted on the digital camera 101.

An access point 102 is connected to a computer 103 via a wired LAN 104.

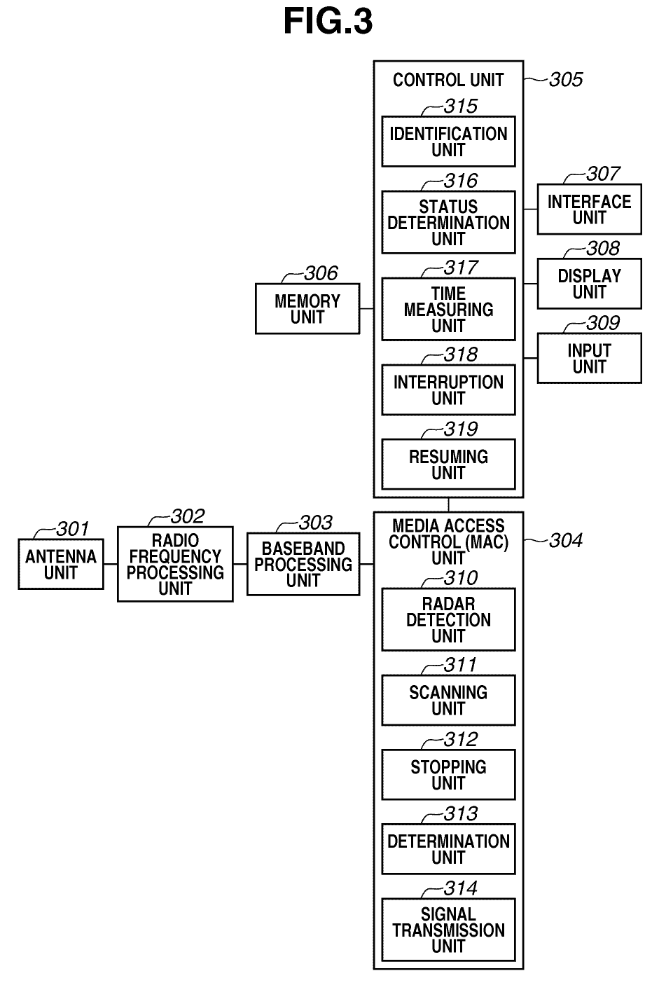

FIG. 3 is a function block diagram illustrating a function configuration related to wireless communication in the digital camera 101. A part or all of the configuration may be provided by the functions of a device attachable to and detachable from the digital camera 101.

An operation of the digital camera 101 to receive data is described below. A radio signal transmitted from the access point 102 is received by an antenna unit 301 and the received signal is converted into a base band signal by a radio-frequency processing unit 302. The base band signal resulting from the above conversion is further converted into a digital signal by a base band processing unit 303. The digital signal undergoes a digital signal process, such as a header process, in the media access control (MAC) unit 304, and sent to a control unit 305.

The media access control unit 304 includes a radar detection unit 310 to detect a radar signal as an example of a first signal transmitted from another wireless system. The media access control unit 304 further includes a scanning unit 311 configured to investigate a status of use of frequency channels of the wireless LAN. Furthermore, the media access control unit 304 includes a stopping unit 312 to stop transmission of a radio signal to the access point 102, and a determination unit 313 to determine whether an annunciation signal (which is broadcasted) is received. An annunciation signal is a beacon signal or an answer signal responding to a search request. A beacon signal is a signal periodically generated from the access point.

The media access control unit 304 further includes a signal transmission unit 314 to transmit a search request signal.

The control unit 305 receives data from the media access control unit 304, stores the data to a memory 306, and transmits the data to an external apparatus or an external unit via an interface unit 307.

The control unit 305 receives data from the external apparatus or the external unit connected to the interface unit 307, stores the data to the memory 306, and transmits the data to the media access control unit 304.

The control unit 305 outputs or transmits the data stored in the memory 306 to the media access control unit 304, or to the external apparatus or the external unit via the interface unit 307.

The control unit 305 executes various data processing and displays processing results on a display unit 308.

The control unit 305 includes an identification unit to identify whether DFS information is included in an annunciation signal, and a status determination unit 316 to determine an operating status of the digital camera 101. The DFS information indicates whether the access point 102 includes a DFS function.

The control unit 305 further includes a time measuring unit 317 to count time, an interruption unit 318 to interrupt data transfer, and a restarting unit 319 to restart data transfer.

An input unit 309 is used to input various settings and commands instructed by a user.

The communication apparatus according to the first exemplary embodiment operates as described below.

The media access control unit 304 connects the digital camera 101 and the access point 102 by using an arbitrary frequency channel. It is assumed that the connection is performed by using a 100ch as an example of the first frequency channel selected from frequency bands shown in FIG. 2. Accordingly, the digital camera 101 and the computer 103 can communicate with each other via the access point 102.

When communication with the computer 103 is established, the user can transfer images stored in the digital camera 101 to the computer 103 by using a protocol, such as a Picture Transfer Protocol (PTP) or a File Transfer Protocol (FTP), for example.

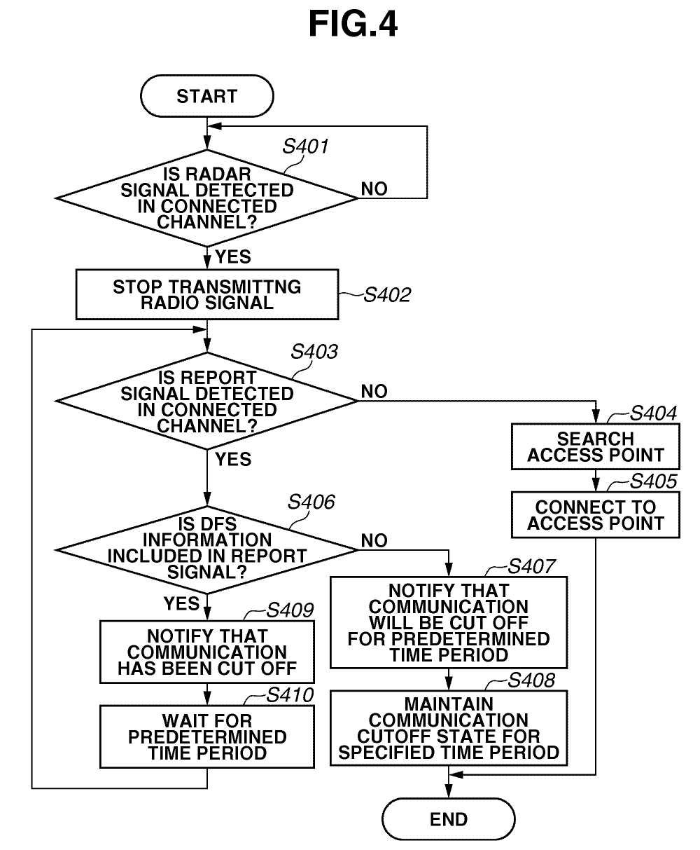

While the digital camera 101 is connected to the access point 102, the control unit 305 controls communication according to the flowchart in FIG. 4. The flowchart is described in detail with reference to FIG. 4.

In step S401, the control unit 305 causes the radar detection unit 310 to detect a radar signal as an example of the first signal, and determines whether a radar signal has been detected. If a radar signal is detected in a frequency channel used in communication with the access point 102 (YES in step S401), the process proceeds to step S402. A radar signal is assumed to have been detected in a 100ch, and the channel in which the radar signal is detected is hereafter referred to as a detected channel.

The radio frequency regulations prohibit communication with the access point 102 by using the detected channel (100ch) for a predetermined time period (30 minutes) after the radar signal has been detected.

While a radar signal is not yet detected (NO in step S401), the control unit 305 periodically determines whether a radar signal is detected by repeating step S401.

In some case, it is only necessary to stop transmitting a radio signal within a predetermined time period (200 ms to 300 ms) after the radar signal is detected. In such a case, the control unit 305 instructs the signal transmission unit 314 to transmit a radar search request signal (Measurement Request) based on IEEE 802.11h within the above-mentioned predetermined time period. The radar search request signal is received by the access point 102. Thus, when the access point 102 includes the DFS function, it is possible to prompt the access point 102 to search for the radar signal.

In step S402, the control unit 305 causes the stopping unit 312 to stop transmitting a radio signal in the detected channel (100ch) to avoid interference with the radar signal. By stopping transmitting the radio signal, the radio frequency regulations can be complied with.

However, if the communication apparatus is left in a standby state under a condition that radio signal transmission is stopped, communication with the access point 102 cannot be performed for the predetermined time period (30 minutes). Therefore, the control unit 305 tries to communicate with the access point 102 using another frequency channel.

In step S403, the access point 102 detects a radar signal by the DFS function, and determines whether a channel for communication has been changed.

In step S403, the control unit 305 causes the scanning unit 311 to perform passive scan on the detected channel (100ch) The passive scan is a scan method to determine whether the digital camera 101 can receive an annunciation signal periodically transmitted from the access point 102 without transmitting a radio signal.

Then, the control unit 305 causes the determination unit 313 to determine whether the annunciation signal from the access point 102 is included in the detected channel (100ch) More specifically, the determination unit 313 determines whether the access point 102 continues communication in the detected channel (100ch). In other words, the determination unit 313 determines a communication status of the access point 102.

If it is determined that the annunciation signal transmitted by the access point 102 is not included in the detected channel (100ch) (NO in step S403), this means that the access point 102 detected the radar signal by its DFS function, and changed the channel for communication. In this case, the process advances to step S404.

In step S404, the control unit 305 causes the media access control unit 304 to search which frequency channels the access point 102 uses when transmitting the annunciation signal. The scanning unit 311 performs the search by performing the passive scan on all frequency channels. It is assumed that the annunciation signal transmitted from the access point 102 is confirmed, for example, in a 120ch which is different from the previous 100ch. The 120ch becomes a second frequency channel as a frequency channel, to which transmission of the radio signal is changed.

A frequency channel to which transmission of the radio signal is changed may also be determined by receiving a channel change notification signal from the access point 102 based on IEEE 802.11h standards. For example, notification that the channel has been changed to the 120ch is transmitted by the access point 102 with the channel change notification signal, for example.

In step S405, the control unit 305 causes the media access control unit 304 to connect to the access point 102 by using the 120ch searched in step S404.

Consequently, even when the station provided with the DFS function detects a radar signal and the DFS function operates, it is possible to avoid suspension of communication for the predetermined time period.

In step S403, on the other hand, if the annunciation signal transmitted from the access point 102 is included in the detected channel (100ch) (YES in step S403), the process advances to step S406.

When the access point 102 is provided with the DFS function, the access point 102 transmits an annunciation signal including DFS information. In step S406, the control unit 305 causes the identification unit 315 to identify the DFS information which is included in an annunciation signal transmitted from the access point 102. Depending on whether the access point 102 includes the DFS function, the control unit 305 can take an appropriate action.

If the DFS information is not included in the annunciation signal transmitted from the access point 102 (NO in step S406), this indicates that the access point 102 does not include the DFS function. Therefore, the access point 102 cannot change the channel by using the DFS function. In this case, the access point 102 does not change the channel (100ch) for communication. However, in compliance with the radio frequency regulations, communication using the 100ch cannot be performed for the predetermined time period (30 minutes), so that the digital camera 101 cannot communicate with the access point 102 for the predetermined time period.

In this case, the process proceeds to step S407. The control unit 305 causes the display unit 308 to display information that communication with the access point 102 is to be disconnected for the predetermined time period. A message to prompt a user to take an appropriate action, for example, a message, “Communication has been disconnected because a radar signal is detected. As the access point is not compatible with DFS, if you want to restart the connection, please manually change the channel of the access point.” may be displayed. A message such as “Communication has been disconnected by DFS. The connection will be restarted 30 minutes later.” or “The communication has been disconnected to prevent interference with a radar signal. The communication will be reconnected 30 minutes later.” may also be displayed.

Accordingly, when communication cannot be performed due to the provisions of the radio frequency regulations which uses DFS, its reason is clearly stated. As a consequence, convenience for users can be improved. Further, convenience for users can be improved by notifying the user of the reason for no communication and prompting the user to respond adequately.

Then, the process proceeds to step S408, and the control unit 305, by following the provisions of the radio frequency regulations, enters into the standby state to maintain a communication disconnected state for the predetermined time period (30 minutes).

By this arrangement, if the access point 102 is not provided with the DFS function, the control unit 305 quickly enters into the standby state without continuing monitoring of the access point 102, which contributes to reducing power consumption. A power saving feature is particularly important for a battery-driven device, such as a digital camera.

On the other hand, in step S406, if the DFS information is included in the annunciation signal transmitted by the access point (YES in step S406), the process advances to step S409. In this case, it can be considered that the access point 102 includes the DFS function, but the radar signal cannot be detected for some reason, for example, the access point 102 is located in a center of a building where it is difficult for external radio waves to reach the access point 102.

In step S409, the control unit 305 causes the display unit 308 to display information that communication with the access point 102 has been disconnected.

Information is displayed to prompt the user to take an appropriate action, such as “Communication has been disconnected because a radar signal is detected. Though the access point supports DFS, the current frequency channel has not been changed. If you want to restart the communication quickly, please change the installation site of the access point.” Or, a message such as “Communication has been disconnected due to interference with a radar signal. Reconnection to the access point is being attempted.” may be displayed.

By the above arrangement, the user can recognize that the communication has been disconnected, so that convenience for users is improved. By changing a display depending whether the access point includes the DFS function or not, the user is prompted to take an appropriate response and convenience for users can be improved.

Then the process advances to step S410, the control unit 305 causes the time measuring unit 317 to measure the predetermined time period to halt the process of the flowchart for that period. After a halt for the predetermined time period, since the access point 102 may have detected a radar signal, the process returns to step S403.

In this manner, the control unit 305 continues monitoring whether an annunciation signal transmitted from the access point 102 is included in the detected channel (100ch in this case). When the access point 102 detects a radar signal during the monitoring, it is possible to start communication by using a different channel (120ch in this case).

In other words, when the access point 102 includes the DFS function, even if the digital camera 101 stops transmitting a radio signal, the control unit 305 continues monitoring the access point 102. Because the control unit 305 continues monitoring, as soon as the access point 102 changes the channel for communication, the control unit 305 can follow up a radar signal. Accordingly, a communication disconnected time period can be shortened.

By halting the process of the flowchart for the predetermined time period, a number of times of scan can be reduced. Thus, processing load and power consumption of the digital camera 101 can be reduced. An exemplary embodiment in which step S410 is omitted, may also be provided in the system.

As described above, even when the access point 102 detects a radar signal later than the communication apparatus (digital camera) according to the present exemplary embodiment, stops communication in the detected channel (100ch in this case), and changes the channel, the control unit 305 can detect change of the channel. In this case, the communication disconnected time period can be shortened.

When the access point does not include the DFS function, convenience for users can be improved by displaying an appropriate instruction for a user together with a message about communication disconnected for a predetermined time period and its reason. Further, since the control unit 305 enters into a standby state quickly, power consumption can be reduced. The power saving feature is particularly important for battery-driven devices such as digital cameras.

When the access point including the DFS function could not detect a radar signal, convenience for users can be improved by displaying an appropriate instruction for a user together with a message that communication will be disconnected and a reason for the disconnection. Because the control unit 305 continues monitoring the access point 102, as soon as the access point 102 changes the channel for communication, the control unit 305 can shift communication to the changed channel. Accordingly, a communication disconnected time period can be shortened.

In the present embodiment, a radar signal has been described as an example of a signal from another wireless system. The present invention is not limited to radar signals but can be applied to other wireless LAN signals such as Bluetooth and ultra wide band (UWB) communication services.

A configuration of a wireless communication system including a wireless communication apparatus according to a second exemplary embodiment of the present invention and the wireless communication apparatus will be described. In the second exemplary embodiment, the digital camera 101 captures images, and sequentially transfers the captured images via the access point 102 to the computer 103.

Since the configuration and the function block diagram of the wireless communication system of the second exemplary embodiment are similar to those described in the first exemplary embodiment, they are designated by the same reference numerals, and their descriptions are not repeated. With regard to a flowchart of the process under control of the control unit 305, those which are described in the first exemplary embodiment are designated by the same reference numerals, and their descriptions are not repeated.

The wireless communication apparatus according to the second exemplary embodiment operates as follows. The control unit 305 instructs the media access control unit 304 to connect the digital camera 101 and the access point 102 by using an arbitrary frequency channel. In this case, they are assumed to be connected using a 100ch. Accordingly, the digital camera 101 and the computer 103 can communicate with each other via the access point 102.

When communication with the computer 103 is established, a user can sequentially transfer captured images to the computer 103 by using a protocol such as FTP. While images are transferred as an example in the present exemplary embodiment, the description can also be applied to cases where data of captured video images or data of recorded sounds is transferred. In other words, data input to the control unit 305 can be transferred sequentially to the computer 103.

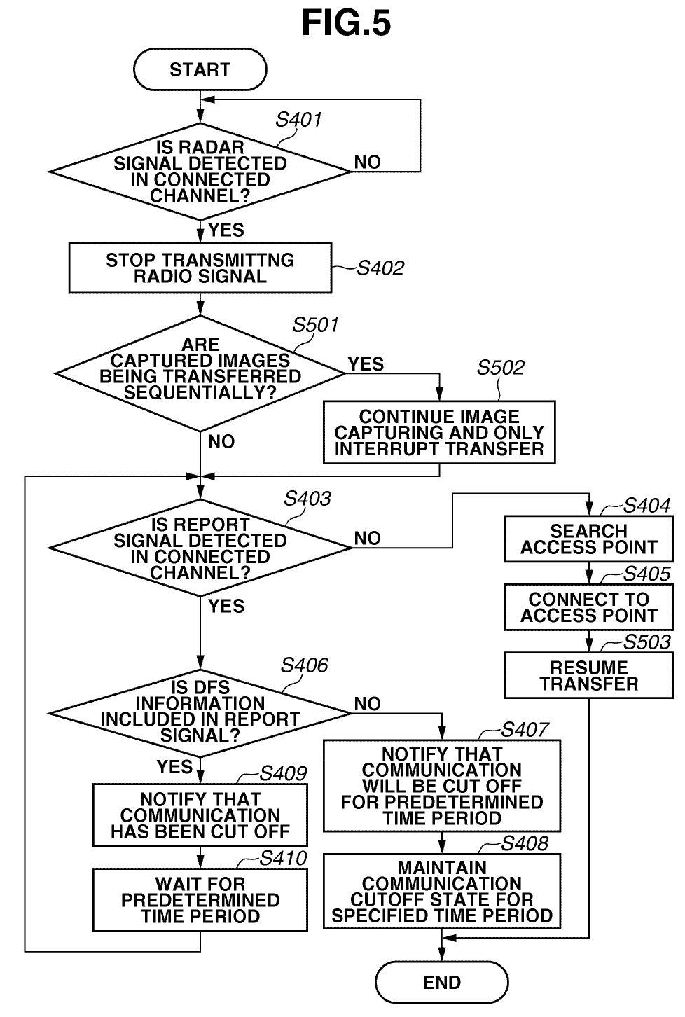

While the digital camera 101 is connected to the access point 102, the control unit 305 controls communication according to the flowchart illustrated in FIG. 5. Next, the flowchart in FIG. 5 will be described in detail.

In step S402, the control unit 305 controls the stopping unit 312 to stop transmitting a radio signal even when the digital camera 101 is sequentially transferring images captured thereby to the computer 103. Then, information indicating that transmission has been stopped is sent to the control unit 305. The control unit 305 responds according to an operating condition of the digital camera 101.

In step S501, the control unit 305 causes the status determination unit 316 to determine whether the digital camera 101 is sequentially transferring captured images. When the captured images are being sequentially transferred (YES in step S501), the process proceeds to step S502.

In step S502, the control unit 305 continues image capturing, but can cause the interruption unit 318 to interrupt the transfer. Data captured hereafter by the digital camera 101 is stored in the memory 306.

By the above arrangement, since image capturing is not interrupted even when the captured images are being transferred sequentially, convenience for users can be improved.

Then, in step S403, the control unit 305 causes the determination unit 313 to determine whether an annunciation signal transmitted from the access point 102 is included in a detected channel (100ch in this case).

If it is determined that the annunciation signal transmitted from the access point 102 is included in the detected channel (100ch) (YES in step S403), the process proceeds to step S406.

On the other hand, if the annunciation signal transmitted from the access point 102 is not included in the detected channel (100ch) (NO in step S403), the process proceeds to step S404, step S405, and step S503.

In step S503, if the transfer is interrupted in step S502, the control unit 305 causes the restarting unit 319 to restart the transfer of images captured by the digital camera 101.

By the above arrangement, when the access point 102 detects a radar signal, the access point 102 starts communication using a different channel (120ch, for example), so that a communication disconnected time can be shortened and captured images can be sequentially transferred.

According to the above described operation, even when captured images are being transferred sequentially, image capturing is not interrupted and convenience for users can be improved. Moreover, when the access point detects a radar signal, a communication disconnected time can be shortened, and captured images can be again transferred sequentially.

According to the present invention, when a signal, such as a radar signal, from another wireless communication system is detected, a communication apparatus which communicates under control of a base station performs processes according to a status or a function of the base station, so that convenience for users can be improved while the apparatus abide by the provisions of radio frequency regulations.

In other words, if the base station has changed the frequency channel when the communication apparatus detects a signal from another wireless system, the communication apparatus can communicate using the changed frequency channel, so that a communication disconnected time can be shortened.

If the base station is communicating on the same frequency channel when the communication apparatus detects a signal from another wireless system, information indicating that communication has been disconnected is displayed, so that a user can be notified of unavailability of communication.

The communication apparatus can flexibly change processes according to whether the base station includes the dynamic frequency selection (DFS) function.

A radar signal has been described as an example of a signal from another wireless system. However, the present invention is not limited to a radar signal and may be applied to other wireless LAN signals such as Bluetooth and UWB communication services.

The present invention includes any flowchart which will be formed by a combination of components of the flowcharts according to each of the exemplary embodiments of the present invention.

The present invention can be realized by supplying a system or an apparatus with a storage medium which stores program code of software that implements the functions of the exemplary embodiments described above. A computer (or a central processing unit (CPU) or a micro processing unit (MPU)) of the system or the apparatus reads and executes the program code stored in the recording medium. In this case, the program code itself read from the storage medium implements the functions of the exemplary embodiments described above, and therefore, the storage medium that stores the program code constitutes the present invention.

The storage medium for supplying the program code may include, for example, a floppy disk, a hard disk, an optical disk, and a magneto-optic disk. Also, a compact disk read only memory (CD-ROM), a CD-recordable (CD-R), a magnetic tape, a nonvolatile memory card, a ROM, and a digital versatile disk DVD may be used.

An operating system (OS) running on the computer may execute a part or all of the actual processes according to commands from the program and implement the functions of the above-described exemplary embodiments.

Moreover, the program code read from the storage medium may be written in a memory in a function expansion board inserted in the computer or in a memory in a function expansion unit connected to the computer. In this case, according to commands of the program code, a CPU in the function expansion board or in the function expansion unit executes a part or all of the processes, and by those processes, the functions of the above-described exemplary embodiments can be implemented.

While the present invention has been described with reference to the exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2008-156898 filed Jun. 16, 2008, which is hereby incorporated by reference herein in its entirety.

What is claimed is:

1. A communication apparatus which performs communication under control of a base station, the communication apparatus comprising:
a detection unit configured to detect a signal sent from another wireless system interfering with a first frequency channel;
a disconnection unit configured to disconnect communication performed in the first frequency channel when the detection unit detects the signal interfering with the first frequency channel;
a determination unit configured to determine whether the base station is communicating using the first frequency channel when the disconnection unit has disconnected communication; and
a control unit configured, when the determination unit determines that the base station is not communicating using the first frequency channel, to search for a second frequency channel which is used by the base station and communicate with the base station by using the searched second frequency channel and/or when the determination unit determines that the base station is communicating using the first frequency channel, to notify a user that communication has been disconnected.

2. The communication apparatus according to claim 1, further comprising an interruption unit configured to interrupt transfer of data when communication is disconnected while the data is being transferred.

3. The communication apparatus according to claim 2, further comprising a restarting unit configured to restart the transfer of data which is interrupted by the interruption unit when communication is restarted by using a frequency channel different from the first frequency channel.

4. The communication apparatus according to claim 1, wherein when the determination unit determines that the base station is communicating using the first frequency channel, the determination unit repeats the determination.

5. A communication apparatus which performs communication under control of a base station, the communication apparatus comprising:
a detection unit configured to detect a signal sent from another wireless system interfering with a first frequency channel;
a disconnection unit configured, when the detection unit detects the signal interfering with the first frequency channel, to disconnect communication using the first frequency channel regardless of whether the base station is communicating using the first frequency channel;
an identification unit configured, when communication has been disconnected by the disconnection unit, to identify whether the base station includes a dynamic frequency selection function; and
a control unit configured to change a process according to a result of the identification by the identification unit.

6. The communication apparatus according to claim 5, wherein if it is identified by the identification unit that the base station includes the dynamic frequency selection function, the control unit determines whether the base station has changed its channel until the base station changes its channel.

7. The communication apparatus according to claim 6, wherein if it is identified by the identification unit that the base station does not include the dynamic frequency selection function, the control unit maintains a disconnected state of communication with the base station without making the determination of whether the base station is communicating using the first frequency channel.

8. The communication apparatus according to claim 5, wherein the control unit displays information according to identification by the identification unit.

9. The communication apparatus according to claim 8, wherein if it is identified by the identification unit that the base station does not include the dynamic frequency selection function, the control unit notifies a user that communication between the communication apparatus and the base station is to be disconnected in a predetermined time period.

10. The communication apparatus according to claim 1, further comprising a requesting unit configured to request the base station to detect a signal from the other wireless system when the detection unit detects a signal from the other wireless system.

11. The communication apparatus according to claim 1, wherein a signal from the other wireless system is a radar signal.

12. A method for controlling a communication apparatus which performs communication under control of a base station, the method comprising:
detecting a signal sent from another wireless system interfering with a first frequency channel;
disconnecting communication using the first frequency channel when the signal interfering with the first frequency channel is detected;
determining whether the base station is communicating using the first frequency channel when communication has been disconnected;
when it is determined that the base station is not communicating using the first frequency channel, searching for a second frequency channel which is used by the base station and communicating with the base station by using the searched second frequency channel; and/or
when it is determined that the base station is communicating using the first frequency channel, notifying a user that communication has been disconnected.

13. A method for controlling a communication apparatus which performs communication under control of a base station, the method comprising:
detecting a signal sent from another wireless system interfering with a first frequency channel;
when the signal interfering with the first frequency channel is detected, disconnecting communication using the first frequency channel regardless of whether the base station is communicating using the first frequency channel;
when communication has been disconnected, identifying whether the base station includes a dynamic frequency selection function; and
changing a process according to a result of the identification.

14. A computer-readable storage medium storing a program to cause a communication apparatus which performs communication under control of a base station, to function as
a detection unit configured to detect a signal sent from another wireless system interfering with a first frequency channel;
a disconnection unit configured to disconnect communication performed in the first frequency channel when the detection unit detects the signal interfering with the first frequency channel;
a determination unit configured to determine whether the base station is communicating using the first frequency channel when the disconnection unit has disconnected communication; and
a control unit configured, when the determination unit determines that the base station is not communicating using the first frequency channel, to search for a second frequency channel which is used by the base station and communicate with the base station using the searched second frequency channel and/or when the determination unit determines that the base station is communicating using the first frequency channel, to notify a user that communication has been disconnected.

15. A computer-readable storage medium storing a program to cause a communication apparatus which performs communication under control of a base station, to function as
a detection unit configured to detect a signal sent from another wireless system interfering with a first frequency channel;
a disconnection unit configured, when the detection unit detects the signal interfering with the first frequency channel, to disconnect communication using the first frequency channel regardless of whether the base station is communicating using the first frequency channel;
an identification unit configured, when communication has been disconnected by the disconnection unit, to identify whether the base station includes a dynamic frequency selection function; and
a control unit configured to change a process according to a result of the identification by the identification unit.
